(19) United States
(12) Patent Application Publication
(10) Pub. No.: US 2016/0161774 A1
(43) Pub. Date: Jun. 9, 2016

(54) OPTICAL DEVICE INCLUDING LIGHT MODULATION DEVICE AND DRIVING METHOD THEREOF

(71) Applicant: SAMSUNG DISPLAY CO., LTD., Yongin-City (KR)

(72) Inventors: Hyun Seung SEO, Gyeonggi-do (KR); Soo Hee OH, Gyeonggi-do (KR); Seung Jun JEONG, Gyeonggi-do (KR)

(21) Appl. No.: 14/706,611

(22) Filed: May 7, 2015

(30) Foreign Application Priority Data
Dec. 4, 2014 (KR) 10-2014-0173326

(51) Int. Cl. G02F 1/137; G02F 1/1337; G02F 1/1335; G02F 1/13363

(52) U.S. Cl. CPC G02F 1/137; G02F 1/13363; G02F 1/1337; G02F 1/133528; G02F 2001/133638

(57) ABSTRACT

The present invention relates to an optical device including a display panel configured to display an image and a phase retardation plate disposed on the display panel. An optical modulation device is disposed on the phase retardation plate. The optical modulation device includes a first substrate and a second substrate facing the first substrate. The first and second substrates include a plurality of unit regions. A liquid crystal layer is disposed between the first substrate and the second substrate. The liquid crystal layer includes a plurality of liquid crystal molecules. The first substrate includes a plurality of lower electrodes including a first electrode and a second electrode. and the first substrate includes a first aligner. The second substrate includes an upper electrode and a second aligner. An alignment direction of the first aligner and an alignment direction of the second aligner are substantially parallel to each other.

### CROSS-REFERENCE TO RELATED APPLICATION

This application claims priority under 35 U.S.C. §119 to Korean Patent Application No. 10-2014-0173326 filed in the Korean Intellectual Property Office on Dec. 4, 2014, the disclosure of which is incorporated by reference herein in its entirety.

### (a) TECHNICAL FIELD

Exemplary embodiments of the present invention relate to an optical device. More particularly, exemplary embodiments of the present invention relate to an optical device including an optical modulation device, and a driving method thereof.

### (b) DISCUSSION OF RELATED ART

Optical devices may include a light modulator for modulating light characteristics. For example, an optical display device that can display a three-dimensional image is attracting attention, and an optical modulation device may divide and output images at different points in time to display a stereoscopic image. The optical modulation device may include a lens and a prism to change a path of the light of the image of the display device and output it at the desired time.

Diffraction of light through phase modulation of the light may be used to change the direction of incident light in this way.

When polarized light passes through a light modulator such as a phase retarder, the polarization state may be changed. For example, when circularly polarized light is transmitted to a half-wave plate, the rotational direction of the circularly polarized light may be reversed and emitted outward. For example, when left circularly polarized light passes through the half-wave plate, it may be changed into right-handed circularly polarized light. At this time, the phase of the circularly polarized light that is emitted may be changed along the angle of the optical axis of the half-wave plate, for example, along the slow axis. When the optical axis of the half-wave plate is rotated by φ in-plane, the phase of the output light may be changed by 2φ. Accordingly, when the change of the optical axis of the half-wave plate is generated as 180 degrees (π radian) in the x-axis direction, the emitted light may have a phase modulation or phase variation of 360 degrees (2π radian) in the x-axis direction. The optical modulation device may convert the phase variation of light from 0 to 2π.

A liquid crystal may be used to control the optical axis along the position of the optical modulation device such as the half-wave plate. In an optical modulation device including the phase retarder using the liquid crystal, an electric field may be applied to the liquid crystal layer to rotate the long axis of the arranged liquid crystal molecules, thereby generating different phase modulations along the positions. The phase of the emitted light through the optical modulation device may be determined depending on the direction of the long axis of the arranged liquid crystals.

### SUMMARY

A continuous phase modulation device including an optical modulation device including liquid crystals may function as a prism, a diffraction lattice and a lens. The liquid crystal molecules may be arranged to have their major axes continuously changed. A phase profile of light may be changed from 0 to 2π according. The optical axes may be changed from 0 to π by a half-wave plate. An alignment process including different directions according to the position of the substrate adjacent to the liquid crystal layer may be relatively complicated. When the alignment process includes finely divided regions, it may be difficult to uniformly perform the alignment process such as a rubbing process and a display failure may appear when used for the display device.

Exemplary embodiments of the present invention include adjusting the planar rotation angle of liquid crystal molecules in the optical modulation device including the liquid crystal to modulate a phase of light.

Exemplary embodiments of the present invention provide an optical modulation device that variously forms a diffraction angle for the progressing direction of light without the complicated driving method to control the rotational direction of the liquid crystal molecules and without the driving circuit of the driving method.

Exemplary embodiments of the present invention allow the optical modulation device to function as the lens to be used in the optical device such as a stereoscopic image display device.

An optical device according to an exemplary embodiment of the present invention includes a display panel configured to display an image and a phase retardation plate disposed on the display panel. An optical modulation device is disposed on the phase retardation plate. The optical modulation device includes a first substrate and a second substrate facing the first substrate. The first and second substrates include a plurality of unit regions. A liquid crystal layer is disposed between the first substrate and the second substrate. The liquid crystal layer includes a plurality of liquid crystal molecules. The first substrate includes a plurality of lower electrodes including a first electrode and a second electrode. The first substrate includes a first aligner. The second substrate includes an upper electrode and a second aligner. An alignment direction of the first aligner and an alignment direction of the second aligner are substantially parallel to each other.

The phase retardation plate may include a quarter-wave plate. The phase retardation plate may include a plurality of first parts and a plurality of second parts alternately disposed in a first direction. A slow axis of the first parts and a slow axis of the second parts may form an angle of substantially 90 degrees.

The optical modulation device may include a first region corresponding to the first parts and a second region corresponding to the second part. The first region and the second region may each respectively include the plurality of unit regions.

The first electrode, the second electrode, and the upper electrode may each be configured to receive different voltages from each other when the optical modulation device is turned on. A phase inclination direction formed by liquid crystal molecules corresponding to the first region and a phase inclination direction formed by liquid crystal molecules corresponding to the second region may be substantially equal to each other.

The display panel may include a polarizer configured to linearly polarize light of the image.

When an electric field is not applied to the liquid crystal layer, a pretilt direction of liquid crystal molecules near the first substrate may be opposite to a pretilt direction of liquid crystal molecules near the second substrate.

The first part and the second part may be inclined with respect to a second direction perpendicular to the first direction.

When an electric field is not applied to the liquid crystal layer, a pretilt direction of the liquid crystal molecules near the first substrate may be opposite to a pretilt direction of the liquid crystal molecules near the second substrate.

When the electric field is applied to the liquid crystal layer, an electric field intensity in a region of the liquid crystal layer near the first electrode may be higher than an electric field intensity in a region of the liquid crystal layer near the second electrode.

An electric field intensity in a region of the liquid crystal layer near the first substrate may be smaller than an electric field intensity in a region of the liquid crystal layer near the second substrate.

The first unit region may include at least one first electrode of the plurality of lower electrodes and the second unit region may include at least one second electrode of the plurality of lower electrodes.

A method for driving an optical device includes respectively applying voltages of different magnitudes to a first electrode and a second electrode disposed in a first region of an optical modulation device of the optical device. The optical device includes a first substrate to form a first phase inclination that is increased along a first direction. Voltages of different magnitudes are respectively applied to a third electrode and a fourth electrode disposed in a second region of the optical modulation device to form a second phase inclination that is increased along the first direction. A phase retardation plate of the optical device includes a quarter-wave plate. The phase retardation plate includes a plurality of first parts and a plurality of second parts alternately disposed in the first direction. A slow axis of the first part and a slow axis of the second part form an angle of substantially 90 degrees. The first region corresponds to the first part, and the second region corresponds to the second part.

In the first region and the second region, a difference between the voltage applied to the first electrode and a voltage applied to an upper electrode disposed on a second substrate of the optical modulation device may be larger than a voltage difference between the voltage applied to the second electrode and the voltage applied to the upper electrode.

The first substrate may include a first aligner. The second substrate may include a second aligner. An alignment direction of the first aligner and an alignment direction of the second aligner may be substantially parallel to each other.

The display panel of the optical device may include a polarizer linearly polarizing light of an image displayed on the display panel.

The method may include applying substantially the same voltage to the first electrode, the second electrode, the third electrode, the fourth electrode, and the upper electrode to turn off the optical modulation device. When an electric field is not applied to the liquid crystal layer of the optical modulation device, a pretilt direction of liquid crystal molecules near the first substrate may be opposite to a pretilt direction of liquid crystal molecules near the second substrate.

The first region and the second region may each include at least one unit region. The optical modulation device may generate a phase variation from 0 to 2π (radian) in at least one of the unit regions.

According to an exemplary embodiment of the present invention, in the optical modulation device including liquid crystals, the in-plane rotational angle of the liquid crystal molecules may be adjusted, thereby modulating the light phase.

The diffraction angle of light may be variously controlled through the optical modulation device without using the driving method for differentiating the rotational direction of the liquid crystal molecules and without the driving circuit of the driving method.

The optical modulation device may function as the lens included in the optical device such as the stereoscopic image display device.

### BRIEF DESCRIPTION OF THE DRAWINGS

FIG. 1 is a schematic cross-sectional view of an optical device according to an exemplary embodiment of the present invention;

FIG. 2 is an exploded perspective view of an optical device according to an exemplary embodiment of the present invention;

FIG. 3 is a perspective view of an optical modulation device according to an exemplary embodiment of the present invention;

FIG. 4 is a top plan view showing an alignment direction in a first substrate and a second substrate included in an optical modulation device according to an exemplary embodiment of the present invention;

FIG. 5 is a view showing an assembly process of the first substrate and the second substrate shown in FIG. 3;

FIG. 6 is a perspective view showing an arrangement of liquid crystal molecules when a voltage difference is not applied to the first substrate and the second substrate of an optical modulation device according to an exemplary embodiment of the present invention;

FIG. 7 is a cross-sectional view of the optical modulation device shown in FIG. 6 taken along planes I, II, and III, respectively;

FIG. 8 is a perspective view showing an arrangement of liquid crystal molecules when a voltage difference is applied to the first substrate and the second substrate of an optical modulation device according to an exemplary embodiment of the present invention;

FIG. 9 is a cross-sectional view of the optical modulation device shown in FIG. 8 taken along planes I, II, and III, respectively;

FIG. 10 is a perspective view of an optical modulation device according to an exemplary embodiment of the present invention;

FIG. 11 is a cross-sectional view showing an arrangement of liquid crystal molecules before a voltage difference is applied to the first substrate and the second substrate of an optical modulation device according to an exemplary embodiment of the present invention taken along planes IV and V of FIG. 10;

FIG. 12 is a cross-sectional view showing an arrangement of liquid crystal molecules after a driving signal is applied to an optical modulation device according to an exemplary embodiment of the present invention taken along the plane IV of FIG. 10;

FIG. 13 is a cross-sectional view showing an arrangement of liquid crystal molecules before stabilizing after a driving signal is applied to an optical modulation device according to an exemplary embodiment of the present invention taken along the plane IV of FIG. 10;

FIG. 14 is a cross-sectional view showing an arrangement of a liquid crystal molecule that is stable after a driving signal is applied to an optical modulation device according to an exemplary embodiment of the present invention taken along the planes IV and V of FIG. 10;

FIG. 15 is a cross-sectional view showing an arrangement of liquid crystal molecules that are stably arranged after a driving signal is applied to an optical modulation device according to an exemplary embodiment of the present invention taken along plane IV of FIG. 10 and a graph showing a phase variation corresponding thereto;

FIG. 16 and FIG. 17 are simulation graphs each showing a phase variation according to a position of light passing through an optical modulation device according to an exemplary embodiment of the present invention;

FIG. 18 is a view showing a phase variation according to a position of a lens included in an optical modulation device according to an exemplary embodiment of the present invention;

FIG. 19 is a view showing a lens realized by using an optical modulation device according to an exemplary embodiment of the present invention; and

FIG. 20 and FIG. 21 are views showing a schematic structure of a stereoscopic image display device as an example of an optical device including an optical modulation device according to an exemplary embodiment of the present invention and a method of displaying a 2D image and a 3D image.

### DETAILED DESCRIPTION OF THE EMBODIMENTS

Exemplary embodiments of the present invention will be described more fully hereinafter with reference to the accompanying drawings. Exemplary embodiments of the present invention may be embodied in different forms and should not be construed as limited to the exemplary embodiments set forth herein.

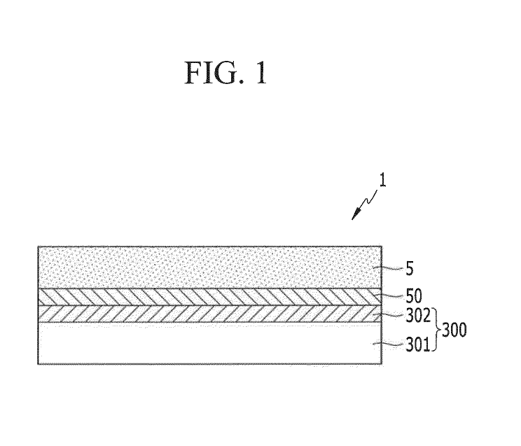

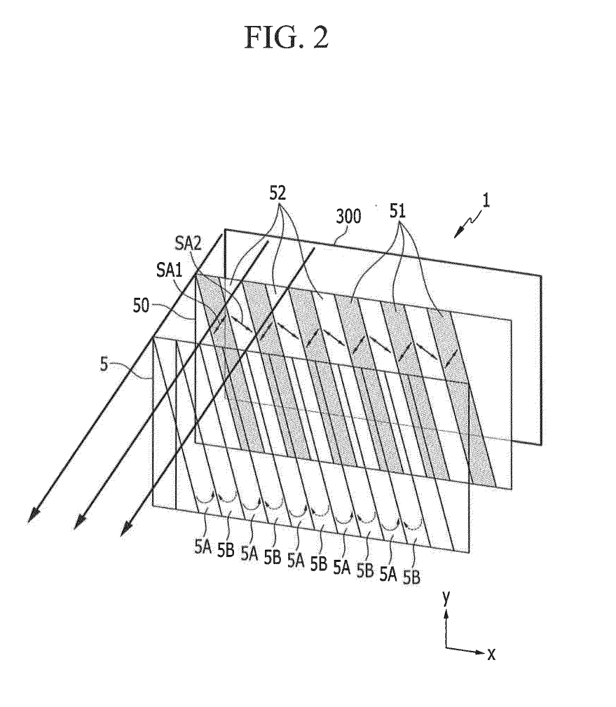

In the drawings, the thickness of layers, films, panels, or regions may be exaggerated for clarity. Like reference numerals may refer to like elements throughout the specification and drawings. It will be understood that when an element such as a layer, film, region, or substrate is referred to as being “on” another element, it may be directly on the other element or intervening elements may be present. An optical device included in an optical modulation device according to an exemplary embodiment of the present invention will now be described in more detail with reference to FIG. 1 and FIG. 2.

FIG. 1 is a schematic cross-sectional view of an optical device according to an exemplary embodiment of the present invention. FIG. 2 is an exploded perspective view of an optical device according to an exemplary embodiment of the present invention.

Referring to FIG. 1 and FIG. 2, an optical device 1 according to an exemplary embodiment of the present invention may be a stereoscopic image display device. The stereoscopic image display device may include a display panel 300, a phase retardation plate 50, and an optical modulation device 5.

The display panel 300 may display a 2D image in a 2D mode and may divide the image corresponding to different viewing points by spatial division or temporal division to alternately display images by position or time in a 3D mode. For example, in the 3D mode, some pixels among a plurality of pixels may display an image corresponding to a first viewing point, and the other pixels may display the image corresponding to a different viewing point. The display panel 300 may include pixels having two or more viewing points.

The display panel 300 may include a plurality of electronic elements configured to display images. For example, the display panel 300 may include an active substrate 301 including a plurality of signal lines and a plurality of pixels. Each of the pixels may be connected to the plurality of signal lines. The display panel 300 may include a polarizer 302 disposed on the active substrate 301. The polarizer 302 may linearly polarize light in a direction parallel to a transmissive axis. The linear polarization direction of the polarizer 302 may be in an x-axis direction or a y-axis direction; however, exemplary embodiments of the present invention are not limited thereto. As shown in FIG. 1, the polarizer 302 may be disposed between the active substrate 301 and the phase retardation plate 50; however, exemplary embodiments of the present invention are not limited thereto.

The display panel 300 may include various display panels such as an organic light emitting panel including an organic light emitting element or a liquid crystal panel including a liquid crystal layer. When the display panel 300 according to an exemplary embodiment of the present invention includes the liquid crystal panel, the display panel 300 may include a pair of polarizers that are respectively disposed on opposite surfaces of the active substrate 301. When the display panel 300 includes the polarizers that are respectively disposed on opposite surfaces of the active substrate 301, the transmissive axes of the two polarizers may be crossed.

The phase retardation plate 50 may be disposed adjacent to a surface in which the image of the display panel 300 is displayed. The phase retardation plate 50 may be a film type plate. The phase retardation plate 50 may be a quarter-wave plate providing phase retardation of a ¼ wavelength to the transmitted light. The light of the image emitted from the display panel 300 may be linearly polarized such that it is circularly polarized through the phase retardation plate 50.

The phase retardation plate 50 according to an exemplary embodiment of the present invention may be a patterned phase retardation plate (e.g., a patterned retarder). The phase retardation plate 50 may include a first part 51 and a second part 52. The first part 51 and the second part 52 may each have a different optical axis or slow axis. The first part 51 and the second part 52 may be alternately disposed in the x-axis direction. A center axis of the first part 51 and a center axis of the second part 52, or boundaries of the first part 51 and the second part 52, may be obliquely inclined with reference to the y-axis direction.

A slow axis SA1 of the first part 51 may be inclined by about 45 degrees with reference to the x-axis direction. A slow axis SA2 of the second part 52 may be inclined by about 135 degrees or −45 degrees with reference to the x-axis direction, and vice versa. According to an exemplary embodiment of the present invention, the slow axis SA1 of the first part 51 may be inclined by about 45 degrees with reference to the x-axis direction and the slow axis SA2 of the second part 52 is inclined by about 135 degrees or −45 degrees with reference to the x-axis direction.

When light passing through the polarizer 302 is linearly polarized and is emitted in the x-axis direction and then passes through the first part 51 of the phase retardation plate 50, left-circular polarized light may be emitted and the right-circular polarized light may be emitted when the linearly polarized light passes through the second part 52 of the phase retardation plate 50. When light passing through the polarizer 302 is linearly polarized and is emitted in the y-axis direction and then passes through the first part 51 of the phase retardation plate 50, right-circular polarized light may be emitted and the left-circular polarized light may be emitted when the linearly polarized light passes through the second part 52 of the phase retardation plate 50.

The optical modulation device 5 may be disposed adjacent to the phase retardation plate 50. The optical modulation device 5 may be an active device for on/off switching. When the optical modulation device 5 is turned on, different phase variations may be generated according to the position of the x-axis direction.

According to an exemplary embodiment of the present invention, the optical modulation device 5 may include a first region 5A and a second region 5B. The first region 5A may correspond with the first part 51 of the phase retardation plate 50 and the second region 5B may correspond with the second part 52 of the phase retardation plate 50. The widths of the first part 51 and the first region 5A may be substantially the same or may have a predetermined difference. The widths of the second part 52 and the second region 5B may be substantially the same or may have a predetermined difference.

The direction of the phase variation of the x-axis direction generated in the first region 5A may be the same as the direction of the phase variation of the x-axis direction generated in the second region 5B. When the optical modulation device 5 is turned on and the forward phase inclination in which the phase retardation value is increased along the x-axis direction in the first region 5A, the forward phase inclination in which the phase retardation value is increased along the x-axis direction may also appear in the second region 5B. When the optical modulation device 5 is turned on and the reverse phase inclination in which the phase retardation value is decreased along the x-axis direction in the first region 5A, the forward phase inclination in which the phase retardation value is decreased along the x-axis direction may also appear in the second region 5B.

A region where the phase retardation value is changed along the x-axis direction from 0 to 2π (radian) or from 2π (radian) to 0 may be referred to as a unit region or a unit. The first region 5A and the second region 5B may each respectively include at least one unit region. When the first region 5A and the second region 5B each respectively include a plurality of unit regions, the width of the plurality of unit regions included in the first region 5A or the second region 5B may be different from each other.

Since the circularly polarized light may be transmitted in different directions in the first region 5A and the second region 5B, the progressing direction passing through the first region 5A and the progressing direction passing through the second region 5B may be different from each other. By differently controlling the progressing angles of the light passing through the first region 5A and the second region 5B, the first region 5A and the second region 5B may function as one lens collecting the light. Accordingly, a pitch of the first part 51 and a pitch of the second part 52 of the phase retardation plate 50 may be about half of the pitch of a plurality of lenses disposed in the optical modulation device 5. The width of the first part 51 or the width of the second part 52 in the x-axis direction may be about half the width of one lens disposed in the optical modulation device 5 in the x-axis direction.

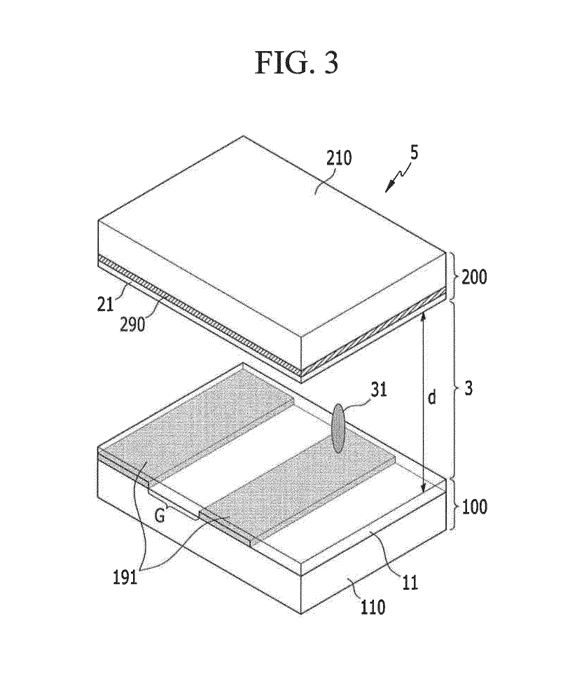

The optical modulation device 5 according to an exemplary embodiment of the present invention will be described in more detail below with reference to FIG. 3 to FIG. 5 as well as the above-described figures.

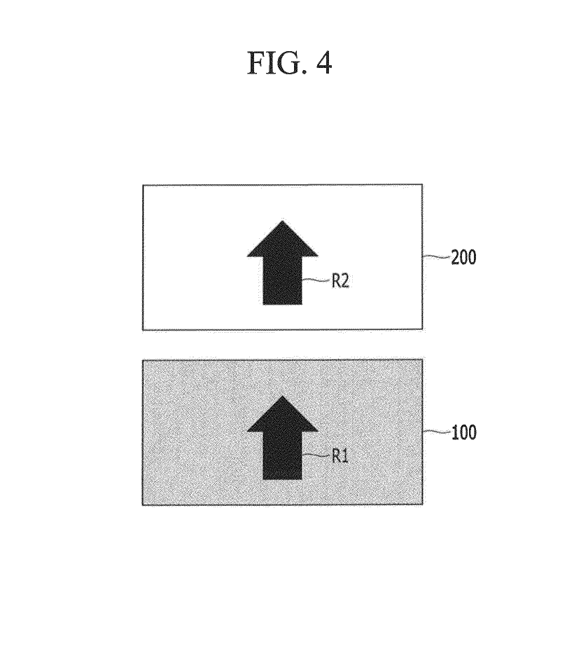

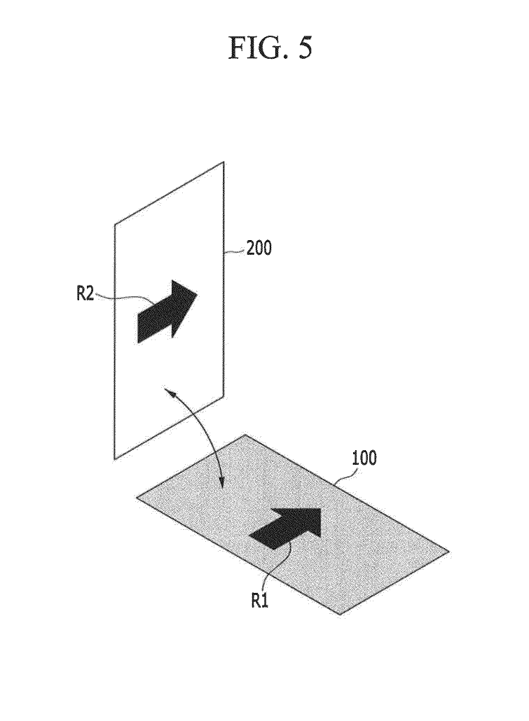

FIG. 3 is a perspective view of an optical modulation device according to an exemplary embodiment of the present invention. FIG. 4 is a top plan view showing an alignment direction in a first substrate and a second substrate included in an optical modulation device according to an exemplary embodiment of the present invention. FIG. 5 is a view showing an assembly process of the first substrate and the second substrate shown in FIG. 3.

Referring to FIG. 3, the optical modulation device 5 according to an exemplary embodiment of the present invention may include a first plate 100 and a second plate 200. The first plate 100 and the second plate 200 may face each other. A liquid crystal layer 3 may be disposed between the first plate 100 and the second plate 200.

The first plate 100 may include a first substrate 110. The first substrate 110 may include glass or plastic. The first substrate 110 may be rigid or flexible, and may be flat or bent. The first substrate 110 may be flat in part and bent in part.

A plurality of lower electrodes 191 may be disposed on the first substrate 110. Each lower electrode 191 may include a conductive material. For example, each lower electrode 191 may include a transparent conductive material such as ITO and IZO, or a metal. The lower electrode 191 may be applied with a voltage from a voltage application unit, and lower electrodes 191 that are adjacent to each other or different from each other may be applied with different voltages.

The plurality of lower electrodes 191 may be disposed in a predetermined direction. For example, the plurality of lower electrodes 191 may be disposed along the x-axis direction. The plurality of lower electrodes 191 may be disposed along a direction perpendicular to the arranged direction, for example, along the y-axis direction.

The width of a space G between the adjacent lower electrodes 191 may vary. For example, the width of the space G may vary depending on the design conditions of the optical modulation device 5. A ratio of the width of the lower electrode 191 and the width of the space G adjacent to the lower electrode 191 may be about N:1 (N is a real number of 1 or more).

The second plate 200 may include a second substrate 210. The second substrate 210 may include glass or plastic. The second substrate 210 may be rigid or flexible, and may be flat or bent. The second substrate 210 may be flat in part and bent in part.

An upper electrode 290 may be disposed on the second substrate 210. The upper electrode 290 may include a conductive material. For example, the upper electrode 290 may include a transparent conductive material such as ITO and IZO or a metal. The upper electrode 290 may be applied with a voltage from the voltage application unit. The upper electrode 290 may be a single body disposed on the second substrate 210, or may be include a plurality of separated portions.

The liquid crystal layer 3 may include a plurality of liquid crystal molecules 31. The plurality of liquid crystal molecules 31 may have a negative dielectric anisotropy. The plurality of liquid crystal molecules 31 may be disposed in a transverse direction with respect to a direction of the electric field generated in the liquid crystal layer 3. The plurality of liquid crystal molecules 31 may be vertically aligned with respect to the second plate 200 and the first plate 100 in the absence of an electric field generated to the liquid crystal layer 3, and may be pre-tilted in a predetermined direction. The plurality of liquid crystal molecules 31 may include nematic liquid crystal molecules.

A height d of the cell gap of the liquid crystal layer 3 may satisfy Equation 1 for the light of a predetermined wavelength (λ). Accordingly, the optical modulation device 5 according to an exemplary embodiment of the present invention may function as an approximate half-wave plate, and may be used as a diffraction lattice or a lens.

$$\frac{λ}{2} \times 1.3 \geq Δ nd \geq \frac{λ}{2} \qquad ( Equation 1 )$$

In Equation 1, Δnd is the phase value of the light passing through the liquid crystal layer 3.

A first aligner 11 may be disposed on an inner surface of the first plate 100 and a second aligner 21 may be disposed on an inner surface of the second plate 200. The first aligner 11 and the second aligner 21 may be vertical alignment layers. The first aligner 11 and the second aligner 21 may have an alignment force produced by various methods such as a rubbing process and photoalignment, thereby determining a pretilt direction of the plurality of liquid crystal molecules 31 near the first plate 100 and the second plate 200. When the alignment force is produced by the rubbing process, the vertical alignment layer may be an organic vertical alignment layer. When the alignment force is produced by the photoalignment process, an alignment material including a photosensitive polymer material may be coated on the inner surface of the first plate 100 and second plate 200 and is the alignment material may be irradiated with light such as ultraviolet rays, to form a photopolymerization material.

Referring to FIG. 4, alignment directions R1 and R2 of the first and second aligners 11 and 21 disposed on inner surfaces of the first plate 100 and the second plate 200, respectively, may be substantially parallel. The alignment directions R1 and R2 of the first and second aligners 11 and 21 may be constant.

When considering a misalignment margin of the first plate 100 and the second plate 200, a difference of the azimuth angle of the first aligner 11 of the first plate 100 and the azimuth angle of the second aligner 21 of the second plate 200 may be about 5 degrees, however, exemplary embodiments of the present invention are not limited thereto.

Referring to FIG. 5, the first plate 100 and the second plate 200 including the first and second aligners 11 and 21 that may be substantially aligned in parallel may be aligned with each other and assembled to form the optical modulation device 5 according to an exemplary embodiment of the present invention.

The vertical positions of the first plate 100 and the second plate 200 may be changed, as desired.

According to an exemplary embodiment of the present invention, the first and second aligners 11 and 21 disposed on the first plate 100 and the second plate 200 of the optical modulation device 5, respectively, may be parallel to each other. Alignment directions of each of the first and second aligners 11 and 21 may be constant and the alignment process of the optical modulation device 5 may be simplified and more complicated alignment processes may be omitted, thereby simplifying the manufacturing process of the optical modulation device 5. Accordingly, a failure rate of the optical modulation device or the optical device including the optical modulation device due to alignment failure may be reduced or prevented. Therefore, a relatively large-sized optical modulation device may be produced.

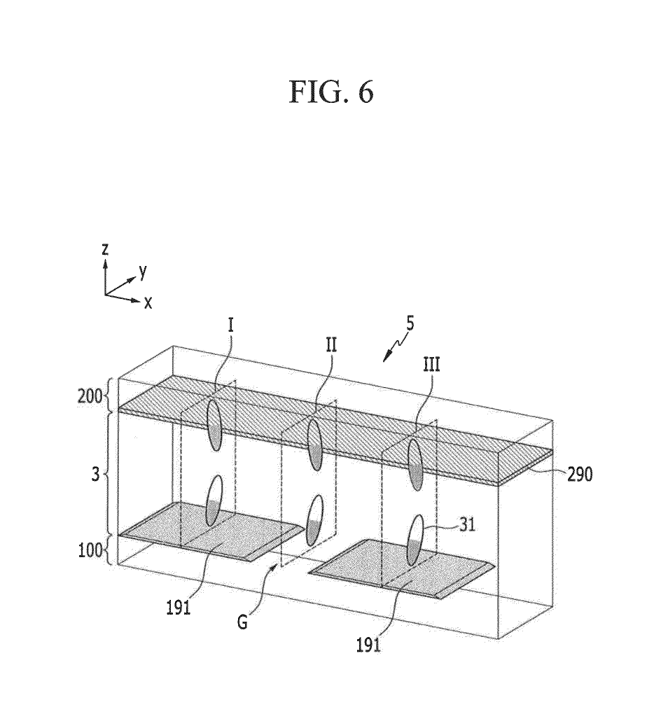

An operation of the optical modulation device according to an exemplary embodiment of the present invention will be described in more detail below with reference to FIG. 6 to FIG. 9 along with the above-described drawings.

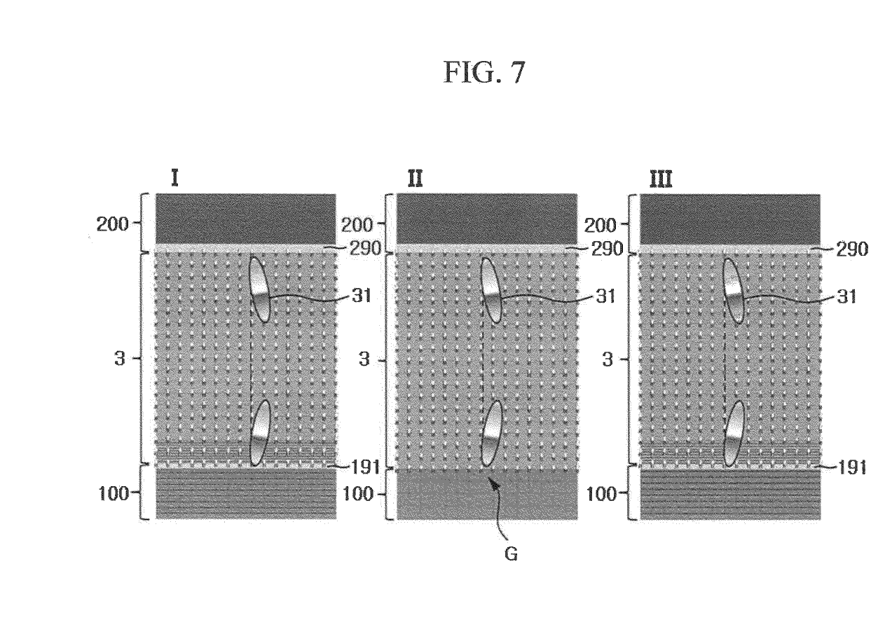

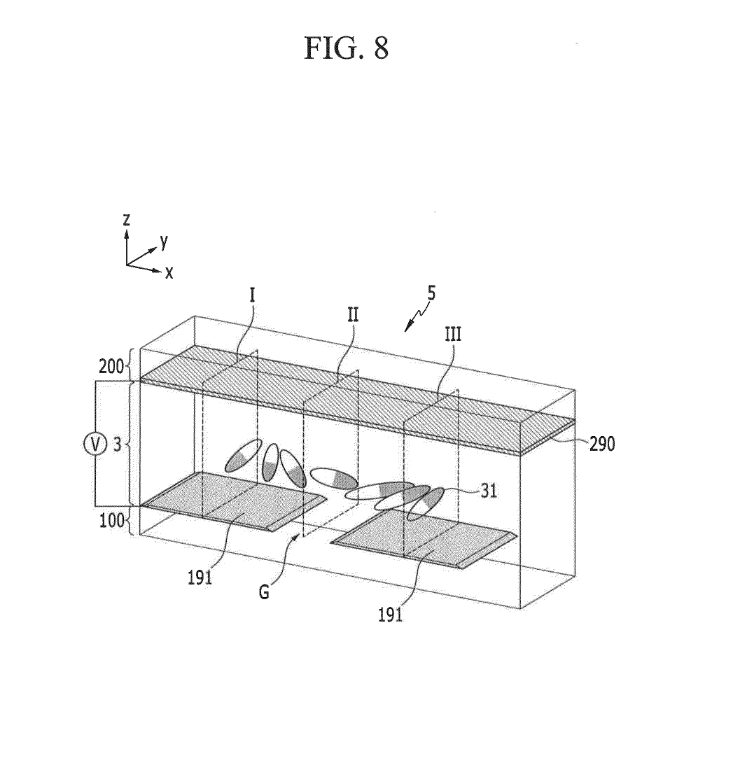

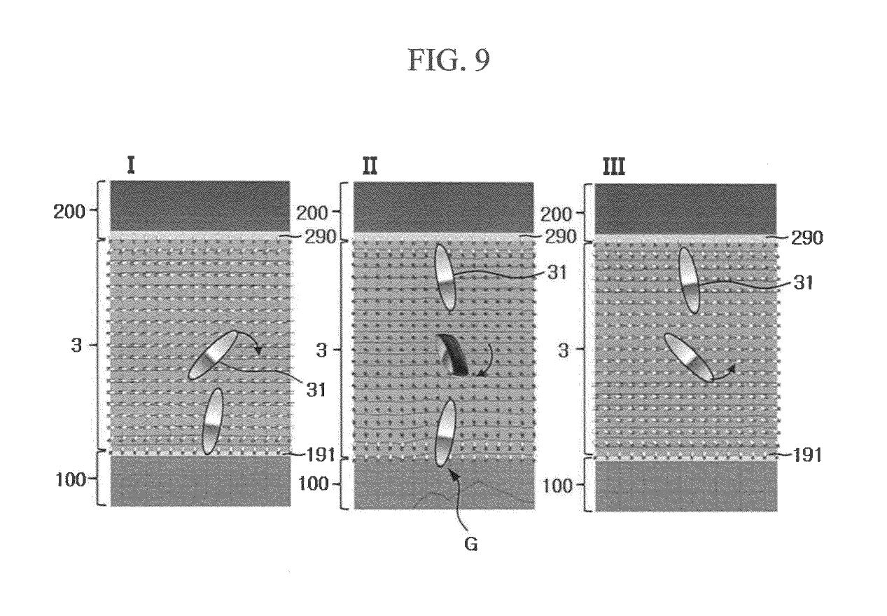

FIG. 6 is a perspective view showing arrangement of liquid crystal molecules when a voltage difference is not applied to the first substrate and the second substrate of an optical modulation device according to an exemplary embodiment of the present invention. FIG. 7 is a cross-sectional view of the optical modulation device shown in FIG. 6 taken along planes I, II, and III, respectively. FIG. 8 is a perspective view showing an arrangement of liquid crystal molecules when a voltage difference is applied to the first substrate and the second substrate of an optical modulation device according to an exemplary embodiment of the present invention. FIG. 9 is a cross-sectional view of the optical modulation device shown in FIG. 8 taken along planes I, II, and III, respectively.

Referring to FIG. 6 and FIG. 7, when the voltage difference is not applied between the lower electrode 191 of the first plate 100 and the upper electrode 290 of the second plate 200 and the electric field is not generated in the liquid crystal layer 3, the plurality of liquid crystal molecules 31 may have an initial pretilt angle. FIG. 7 includes a cross-sectional view taken along plane I corresponding to a first lower electrode 191 among a plurality of lower electrodes 191 of the optical modulation device 5 shown in FIG. 6, a cross-sectional view taken along plane 11 corresponding to the space G between two adjacent lower electrodes 191, and a cross-sectional view taken along plane III corresponding to a second lower electrode 191 adjacent to the first lower electrode 191. The arrangement of the plurality of liquid crystal molecules 31 may be constant.

In the drawing of FIG. 7, some of the liquid crystal molecules 31 may penetrate the region of the first plate 100 or the second plate 200; however, the liquid crystal molecules 31 might not penetrate the region of the first plate 100 or the second plate 200.

The liquid crystal molecules 31 near the first plate 100 and the second plate 200 may be initially aligned along the alignment direction parallel to the first and second aligners 11 and 21 and the pretilt direction of the liquid crystal molecule 31 near the first plate 100 and the pretilt direction of the liquid crystal molecule 31 near the second plate 200 might not be parallel to each other, but may be opposite to each other. The liquid crystal molecule 31 near the first plate 100 and the liquid crystal molecule 31 near the second plate 200 may be inclined to be symmetrical to each other with reference to a transverse center line extending transversely along the center of the liquid crystal layer 3. For example, if the liquid crystal molecule 31 near the first plate 100 may be inclined in a first direction (e.g. rightward), the liquid crystal molecule 31 near the second plate 200 may be inclined in a second direction opposite to the first direction (e.g., leftward).

Referring to FIG. 8 and FIG. 9, a voltage difference of more than a threshold voltage may be applied between the lower electrode 191 of the first plate 100 and the upper electrode 290 of the second plate 200 such that the liquid crystal molecules 31 having negative dielectric anisotropy may tend to be inclined in the direction perpendicular to the direction of the electric field directly after the electric field is applied to the liquid crystal layer 3. Accordingly, as shown in FIG. 8 and FIG. 9, the liquid crystal molecules 31 may be inclined to be parallel to the surface of the first plate 100 or the second plate 200 to have an in-plane arrangement and the long axes of the liquid crystal molecules 31 may be rotated in-plane. When the liquid crystal molecules 31 are rotated in-plane the long axis of the liquid crystal molecules 31 may be parallel to the surface of the first plate 100 or the second plate 200.

The rotation angle on the in-plane of the liquid crystal molecule 31 (e.g., the azimuthal angle) may be changed depending on the voltage applied to the lower electrode 191 and the upper electrode 290. The rotation angle may be changed to a spiral depending on the position of the x-axis direction.

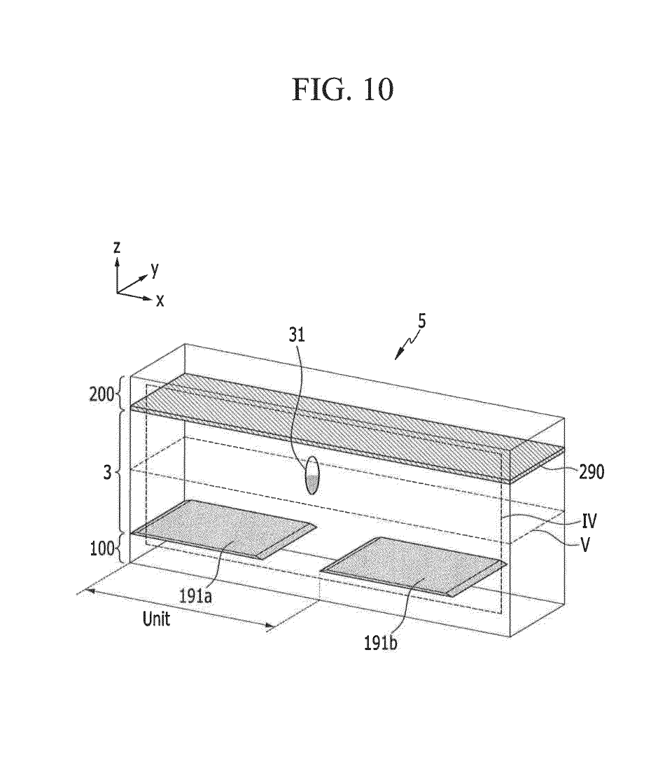

The driving method and the operation of the optical modulation device 5 according to an exemplary embodiment of the present invention will be described in more detail below with reference to FIG. 10 to FIG. 15 along with the previously described drawings.

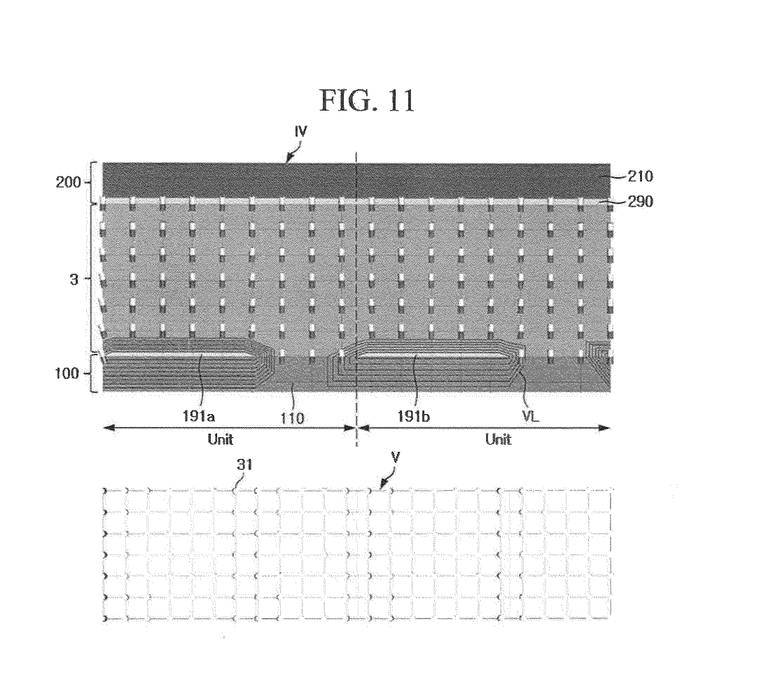

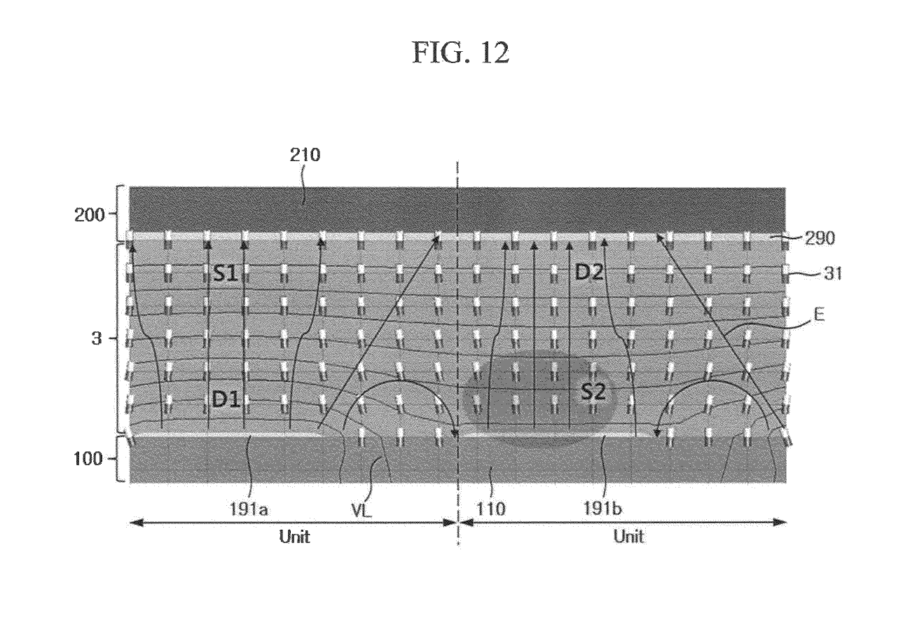

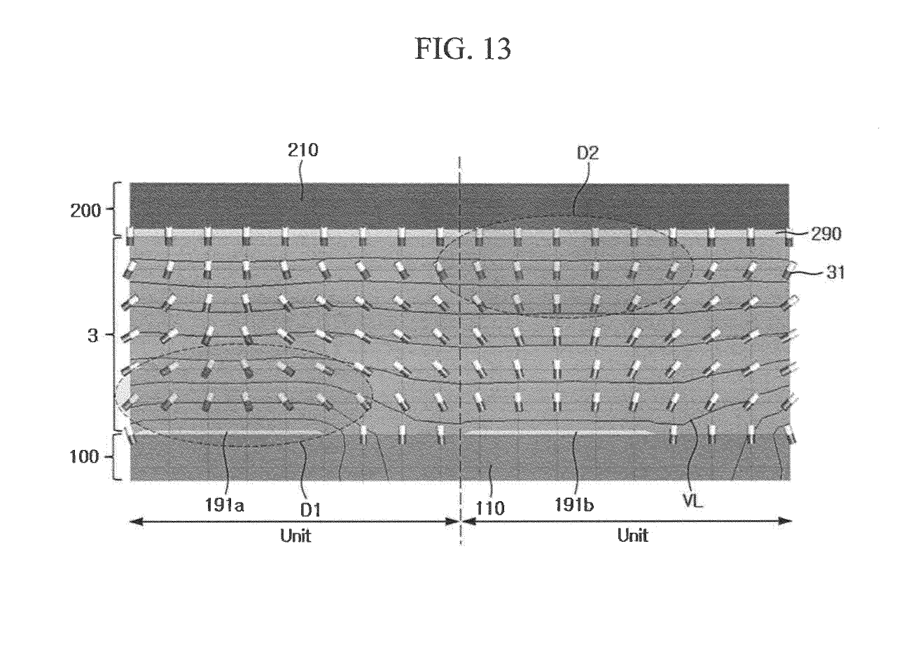

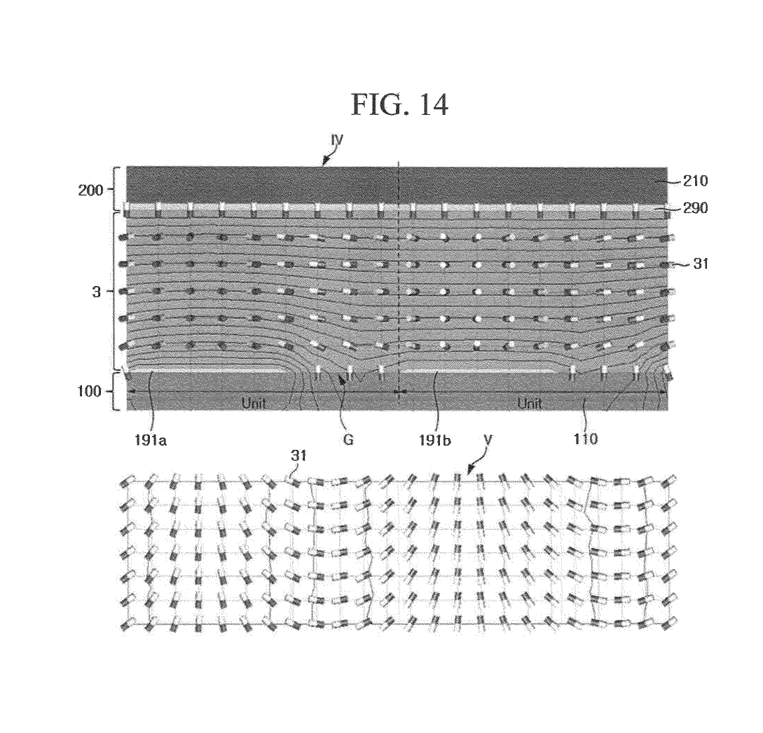

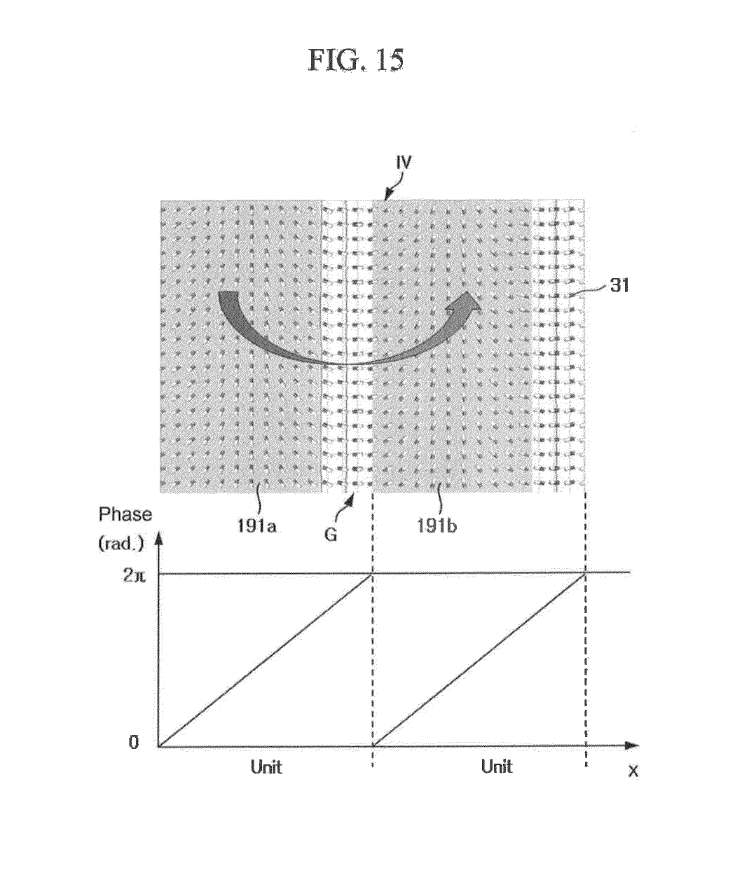

FIG. 10 is a perspective view of an optical modulation device according to an exemplary embodiment of the present invention. FIG. 11 is a cross-sectional view showing an arrangement of liquid crystal molecules before a voltage difference is applied to the first substrate and the second substrate of an optical modulation device according to an exemplary embodiment of the present invention taken along planes IV and V of FIG. 10. FIG. 12 is a cross-sectional view showing an arrangement of liquid crystal molecules after a driving signal is applied to an optical modulation device according to an exemplary embodiment of the present invention taken along the plane IV of FIG. 10. FIG. 13 is a cross-sectional view showing an arrangement of liquid crystal molecules before stabilizing after a driving signal is applied to an optical modulation device according to an exemplary embodiment of the present invention taken along the plane IV of FIG. 10. FIG. 14 is a cross-sectional view showing an arrangement of a liquid crystal molecule that is stable after a driving signal is applied to an optical modulation device according to an exemplary embodiment of the present invention taken along the planes IV and V of FIG. 10. FIG. 15 is a cross-sectional view showing an arrangement of liquid crystal molecules that are stably arranged after a driving signal is applied to an optical modulation device according to an exemplary embodiment of the present invention taken along the plane IV of FIG. 10 and a graph showing a phase variation corresponding thereto.

FIG. 10 shows the optical modulation device 5 including the liquid crystal layer 3 according to an exemplary embodiment of the present invention. The optical modulation device 5 may include the plurality of unit regions, and each unit region may include at least one lower electrode 191. According to an exemplary embodiment of the present invention, each unit region may include one lower electrode 191, and two lower electrodes 191a and 191b disposed in two adjacent unit regions. The two lower electrodes 191a and 191b may be referred to as a first electrode 191a and a second electrode 191b.

FIG. 11 is a cross-sectional view showing the arrangement of the liquid crystal molecules 31 before the voltage difference is applied between the first and second electrodes 191a and 191b of the first plate 100 and the upper electrode 290 of the second plate 200 in the optical modulation device 5 shown in FIG. 10 taken along the planes IV and V of FIG. 10. The liquid crystal molecules 31 may be initially aligned in the direction substantially perpendicular to the surface of the first plate 100 and the second plate 200. The liquid crystal molecules 31 may be pretilted along the alignment directions R1 and R2 of the first plate 100 and the second plate 200. Equipotential lines VL in the liquid crystal layer 3 are shown in FIG. 11. Substantially the same voltage (e.g., 0 V) may be applied to the first and second electrodes 191a and 191b and the upper electrode 290, and the optical modulation device 5 may be the turned-off state.

FIG. 12 is a cross-sectional view showing the arrangement of the liquid crystal molecules 31 after the initial voltage difference is applied between the first and second electrodes 191a and 191b of the first plate 100 and the upper electrode 290 of the second plate 200 in the optical modulation device 5 shown in FIG. 10 taken along the plane IV of FIG. 10. The electric field E may be applied to the liquid crystal layer 3. Since the first and second electrodes 191a and 191b may have an edge side, as shown in FIG. 12, for example, a fringe field may be applied between the edge side of the first and second electrodes 191a and 191b and the upper electrode 290.

The voltage of the driving signal applied to the first and second electrodes 191a and 191b and the upper electrode 290 may be determined according to an intensity distribution of the electric field E shown in FIG. 12.

In the liquid crystal layer 3 of the unit region including the second electrode 191b directly after the driving signal is applied to the first and second electrodes 191a and 191b and the upper electrode 290, the intensity of the electric field in the region D1 near the first plate 100 may be larger than the intensity of the electric field in the region S1 near the second plate 200. In the liquid crystal layer 3 of the unit region including the first electrode 191a, the intensity of the electric field in the region S2 near the first plate 100 may be weaker than the electric field in the region D2 near the second plate 200.

The voltages applied to the first electrode 191a and the second electrode 191b of two adjacent unit regions may have the difference (unit) as shown in FIG. 12. The intensity of the electric field in the region S2 near the second electrode 191b may be weaker than the intensity of the electric field in the region D1 near the first electrode 191a.

When the voltage applied to the first electrode 191a and the second electrode 191b is positive with reference to the voltage of the upper electrode 290, the voltage applied to the first electrode 191a may be higher than the voltage applied to the second electrode 191b. When the voltage applied to the first electrode 191a and the second electrode 191b is negative with reference to the voltage of the upper electrode 290, the voltage applied to the first electrode 191a may be lower than the voltage applied to the second electrode 191b. The upper electrode 290 may be applied with the voltage that is different from the voltage applied to the first and second electrodes 191a and 191b. For example, a lower voltage may be applied to the upper electrode 290 (e.g., 0 V) than the voltage that is applied to the first and second electrode 191a and 191b.

FIG. 13 is a cross-sectional view showing the arrangement of the liquid crystal molecules 31 that react to the electric field E applied to the liquid crystal layer 3 after the driving signal is applied to the optical modulation device 5, taken along the plane IV of FIG. 10. In the liquid crystal layer 3 corresponding to the first electrode 191a, the electric field in the region D1 near the first electrode 191a may be relatively the strongest such that the inclined direction of the liquid crystal molecules 31 of the region D1 determines the in-plane arrangement direction of the liquid crystal molecules 31 corresponding to the second electrode 191b. Accordingly, in the region corresponding to the second electrode 191b, the liquid crystal molecules 31 are inclined in the initial pretilt direction of the liquid crystal molecules 31 near the first plate 100, thereby forming the in-plane arrangement.

In the liquid crystal layer 3 corresponding to the second electrode 191b, the electric field in the region D2 near the upper electrode 290 facing the first electrode 191a may be relatively the strongest such that the inclined direction of the liquid crystal molecules 31 of the region D2 determines the in-plane arrangement direction of the liquid crystal molecules 31. Accordingly, in the region corresponding to the first electrode 191a, the liquid crystal molecules 31 may be increased in the initial pretilt direction near the second plate 200, thereby forming the in-plane arrangement. The initial pretilt direction of the liquid crystal molecules 31 near the first plate 100 and the initial pretilt direction of the liquid crystal molecules 31 near the second plate 200 may be opposite to each other such that the inclined direction of the liquid crystal molecules 31 corresponding to the first electrode 191a may be opposite to the inclined direction of the liquid crystal molecules 31 corresponding to the second electrode 191b.

FIG. 14 is a cross-sectional view showing the arrangement of the stable liquid crystal molecules 31 after the driving signal is applied to the optical modulation device 5 shown in FIG. 10 taken along the planes IV and V of FIG. 10. The in-plane arrangement direction of the liquid crystal molecules 31 corresponding to the first electrode 191a may be opposite to the in-plane arrangement direction of the liquid crystal molecules 31 corresponding to the second electrode 191b. The liquid crystal molecules 31 corresponding to the space G between the adjacent first electrode 191a and second electrode 191b may be continuously rotated along the x-axis direction, thereby forming the spiral arrangement.

Referring to FIG. 14 and FIG. 15, the spiral arrangement of the liquid crystal molecules 31 may form a “U” shape. The region where the liquid crystal molecules 31 are rotated along the x-axis direction by 180 degrees may be referred to as one unit region. According to an exemplary embodiment of the present invention, one unit region (unit) may include the space G between the first electrode 191a and the second electrode 191b, which may be adjacent to the first electrode 191a.

The liquid crystal layer 3 of the optical modulation device 5 may provide phase retardation that is changed along the x-axis direction for light that is transmitted to the optical modulation device 5. The optical modulation device 5 may be in the turned-on state when the phase retardation is changed along the x-axis direction by applying the driving signal to the first and second electrodes 191a and 191b and the upper electrode 290.

The optical modulation device 5 may satisfy Equation 1 when used as the half-wave plate, and the rotational direction of the incident and circularly-polarized light may be reversed. FIG. 15 shows the phase variation according to the position in the x-axis direction when the right-circularly polarized light is transmitted to the optical modulation device 5. The right-circularly polarized light passing through the optical modulation device 5 may be changed into the left-circularly polarized light. The phase retardation value of the liquid crystal layer 3 may vary with respect to the x-axis direction such that the phase of the circularly-polarized light is continuously changed.

When the optical axis of the half-wave plate is rotated by φ with respect to the in-plane orientation, since the phase of the output light may be changed by 2φ, as shown in FIG. 15, the phase of the light transmitted to one unit region where the azimuth angle of the long axis of the liquid crystal molecules 31 is changed by 180 degrees may be changed along the x-axis direction from 0 to 2π (radian). This may be referred to as a foreword phase inclination. This forward phase inclination may be applied in each of the unit regions, and in the phase inclination portion or the reverse phase inclination portion of the lens changing the light. The light may be circularly-polarized in the predetermined direction and may be passed through the optical modulation device 5, thus forming the foreword phase inclination.

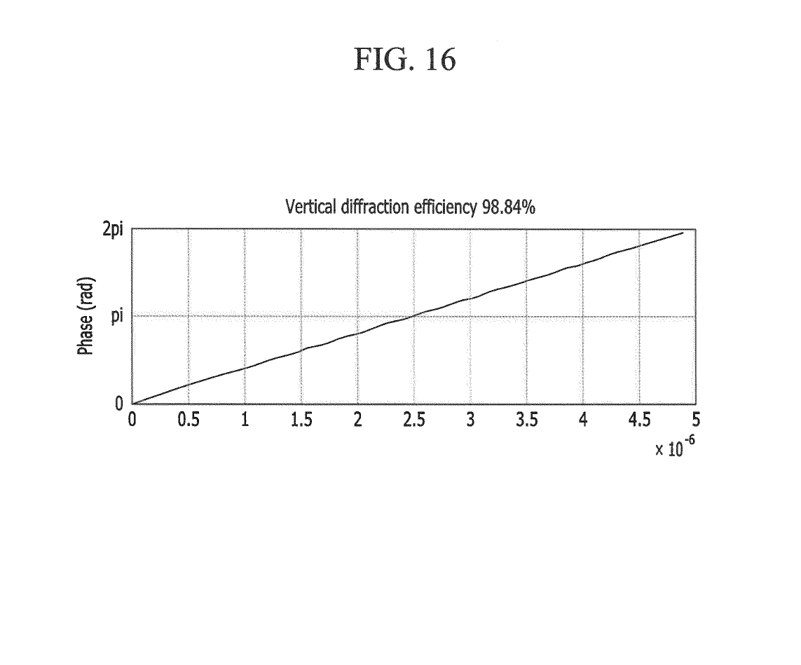

FIG. 16 is a simulation graph showing the phase variation according to the position of the passed light when the right-circularly polarized light is transmitted to the optical modulation device 5. The optical modulation device may be turned on by the application of the driving signal and may include the plurality of liquid crystal molecules 31 arranged as shown in FIG. 4.

When the left-circularly polarized light is transmitted to the optical modulation device 5 that is turned on by the application of the driving signal and including the liquid crystal molecules 31 arranged as shown in FIG. 14, the light phase may be changed in the x-axis direction from 2π (radian) to 0. This may be referred to as a reverse phase inclination. The reverse phase inclination may be applied in each of the unit regions, and in the reverse phase inclination portion of the lens changing the direction of the light, which may be transmitted through the optical modulation device 5.

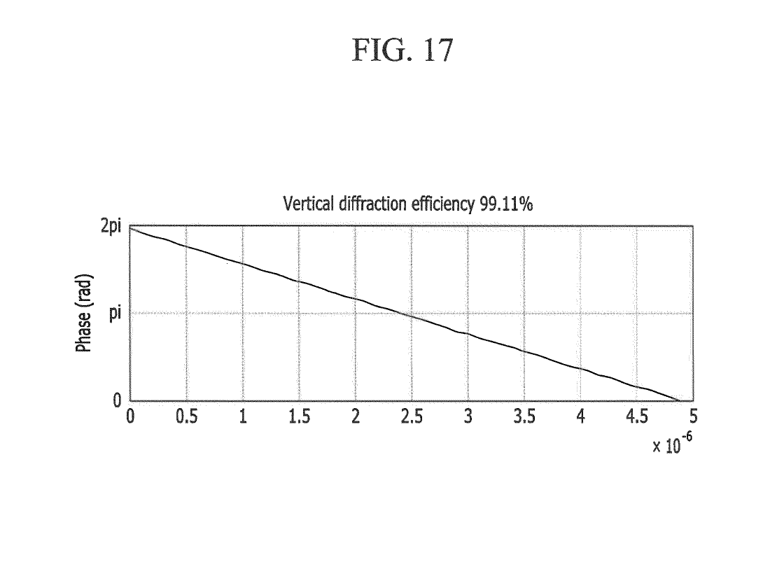

FIG. 17 is a simulation graph showing the phase variation according to the position of the passed light when the left-circularly polarized light is transmitted to the optical modulation device 5. The optical modulation device 56 may be turned on by the application of the driving signal.

The light phase may be changed by adjusting the in-plane rotation angle of the liquid crystal molecules 31 of the optical modulation device 5 according to an exemplary embodiment of the present invention.

The direction of the phase inclination of the light may be different depending on the circular polarization direction of the light transmitted through the turned-on optical modulation device 5 such that the progressing angle of the light may be variously formed without using the driving method to variously control the rotational direction of the liquid crystal molecules 31 and without using the driving circuit for the driving method.

The optical modulation device 5 may be turned on by using three voltages applied to the first electrode 191a, the second electrode 191b, and the upper electrode 290. The reverse phase inclination portion and the foreword phase inclination portion of one lens may be realized by using the phase retardation plate 50. The manufacturing cost and the power consumption may be reduced without using the driving circuit and the driving method.

According to an exemplary embodiment of the present invention, the liquid crystal molecules 31 of the liquid crystal layer 3 may form an “n” shape arrangement by changing the driving signal applied to the first and second electrodes 191a and 191b in several steps, or the voltage application method. When right-circularly polarized light passes through the optical modulation device 5, the phase retardation may be generated depending on the reverse phase inclination, and when left-circularly polarized light passes through the optical modulation device 5, the phase retardation may be generated depending on the foreword phase inclination.

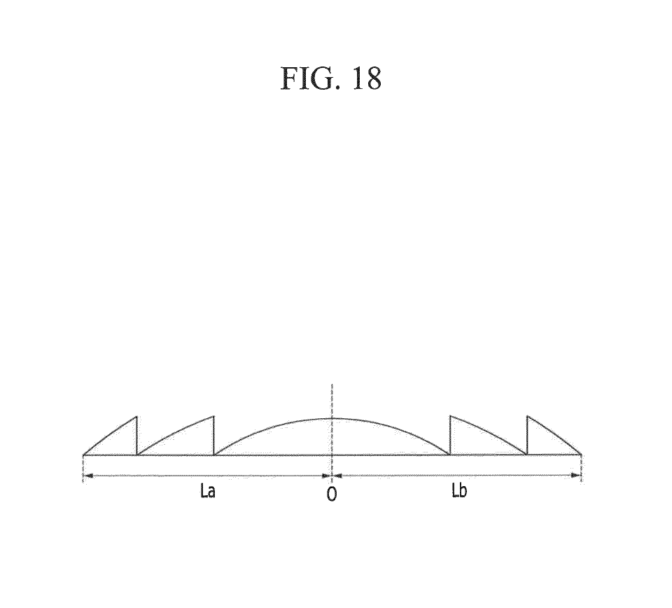

FIG. 18 shows the phase variation according to the position of the lens of the optical modulation device 5 and the phase retardation plate 50 according to an exemplary embodiment of the present invention.

The foreword phase inclination and the reverse phase inclination may both be realized depending on the circular-polarization direction of the light transmitted through the optical modulation device 5 according to an exemplary embodiment of the present invention, thereby forming the lens. FIG. 18 shows the phase variation depending on the position of a Fresnel lens as an example of the lens of the optical modulation device 5. The Fresnel lens may include an optical characteristic of a Fresnel zone plate, and may have an effective phase delay which is identical or similar to that of a solid convex lens or a GRIN lens since the refractive index distribution may be periodically repeated.

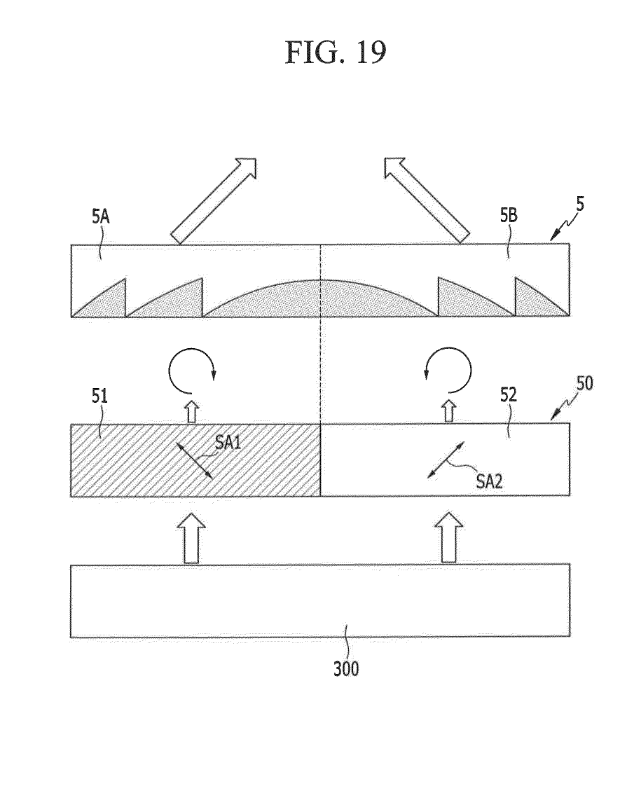

FIG. 19 is a view showing a lens realized by using an optical modulation device according to an exemplary embodiment of the present invention.

Referring to FIG. 18 and FIG. 19, the image displayed in the display panel 300 may be linearly polarized by the polarizer 302 and may be transmitted to the phase retardation plate 50. According to an exemplary embodiment of the present invention, light may be linearly polarized in the y-axis direction and may be transmitted to the phase retardation plate 50. Linearly polarized light transmitted to the first part 51 of the phase retardation plate 50 may be right-circularly polarized and may be transmitted along the slow axis SA1 that may be inclined by 45 degrees with reference to the x-axis direction. Linearly polarized light transmitted to the second part 52 may be left-circularly polarized and may be transmitted along the slow axis SA2 that may be inclined by 135 degrees with reference to the x-axis direction. The right-circularly polarized light may be transmitted to the first region 5A of the turned-on optical modulation device 5, and the left-circularly polarized light may be transmitted to the second region 5B of the turned-on optical modulation device 5.

The right-circularly polarized light transmitted to the first region 5A may undergo foreword phase inclination that is changed from 0 to 2π (radian) along the x-axis direction. The first region 5A may include a left portion La with reference to a center O of the Fresnel lens. The left-circularly polarized light transmitted to the second region 5B may undergo reverse phase inclination that is changed from 2π (radian) to 0 along the x-axis direction. The second region 5B may include a right portion Lb with reference to the center O of the Fresnel lens.

A plurality of foreword phase inclinations of the left portion La and the right portion Lb of the Fresnel lens realized by the optical modulation device 5 may have different widths depending on a position of the Fresnel lens. The width of the lower electrode 191 of the optical modulation device 5 corresponding to each foreword phase inclination portion and/or the number of lower electrode 191s included in one unit region may be adjusted according to a position of the Fresnel lens. The phase curvature of the Fresnel lens may be adjusted according to the voltage applied to the lower electrode 191 and the upper electrode 290.

According to an exemplary embodiment of the present invention, without the use of the driving method and the driving circuit of the driving method, light may be transmitted in different directions through the optical modulation device 5 and the phase retardation plate 50, and the diffraction angle of the light may be variously formed to function as the Fresnel lens.

This optical modulation device 5 may function as the lens to be used in the optical device (e.g., optical device 1) such as the stereoscopic image display device.

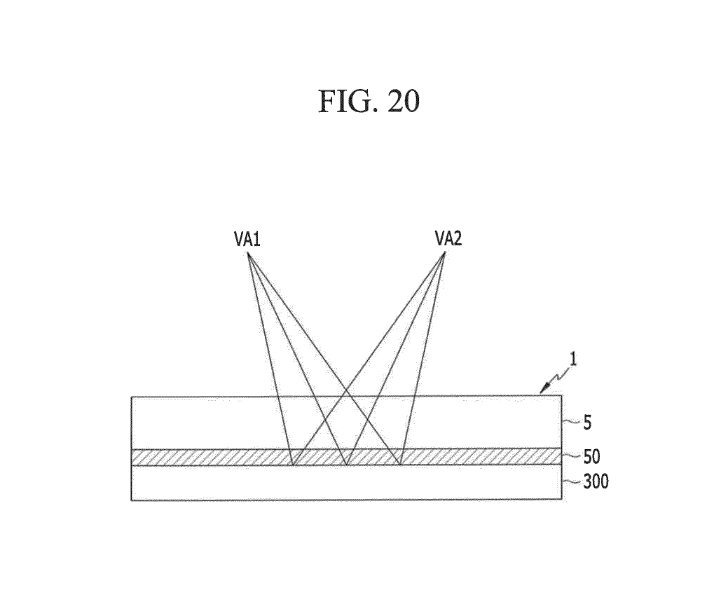

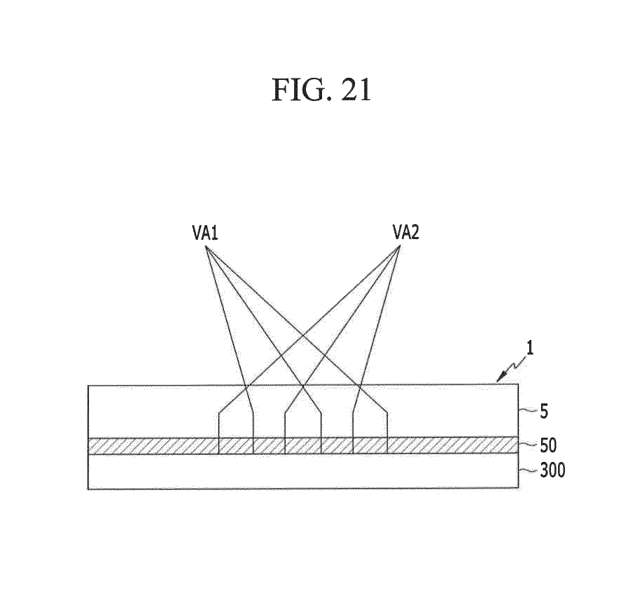

FIG. 20 and FIG. 21 are views showing a schematic structure of a stereoscopic image display device as an example of an optical device using an optical modulation device according to an exemplary embodiment of the present invention and a method displaying a 2D image and a 3D image.

Referring to FIG. 20 and FIG. 21, the stereoscopic image display device may include the optical device 1 according to an exemplary embodiment of the present invention.

The display panel 300 may display the 2D image of each frame in the 2D mode as shown in FIG. 20, and may display the 3D image by spatially dividing various viewpoint images such as a left eye image (e.g., VA1) and a right eye image (e.g., VA2) by a spatial division method in a 3D mode as shown in FIG. 21. In the 3D mode, some of the pixels may display an image corresponding to one viewpoint, and other pixels may display an image corresponding to another viewpoint. The number of viewpoints may be two or more.

The optical modulation device 5 and the phase retardation plate 50 may function as the Fresnel lens including a plurality of foreword phase inclination portions and a plurality of reverse phase inclination portions to divide the image displayed in the display panel 300 for each viewing point.

The optical modulation device 5 may function as an on/off switching device. If the optical modulation device 5 is turned on, the stereoscopic image display device may be operated in the 3D mode, and as shown in FIG. 21, and the image displayed in the display panel 300 may be refracted to form a plurality of Fresnel lenses to display the image at the corresponding viewing points. If the optical modulation device 5 is turned off, as shown in FIG. 20, the image displayed in the display panel 300 might not be refracted and the 2D image may be displayed.

While the present invention has been shown and described with reference to the exemplary embodiments thereof, it will be apparent to those of ordinary skill in the art that various changes in form and detail may be made thereto without departing from the spirit and scope of the present invention.

What is claimed is:

1. An optical device comprising:
a display panel configured to display an image;
a phase retardation plate disposed on the display panel; and
an optical modulation device disposed on the phase retardation plate,
wherein the optical modulation device includes:
a first substrate and a second substrate facing the first substrate, wherein each of the first substrate and the second substrate include a plurality of unit regions, and
a liquid crystal layer disposed between the first substrate and the second substrate, wherein the liquid crystal layer includes a plurality of liquid crystal molecules,
wherein the first substrate includes a plurality of lower electrodes including a first electrode and a second electrode, and wherein the first substrate includes a first aligner,
wherein the second substrate includes an upper electrode and a second aligner, and
wherein an alignment direction of the first aligner and an alignment direction of the second aligner are substantially parallel to each other.

2. The optical device of claim 1, wherein the phase retardation plate includes a quarter-wave plate,
wherein the phase retardation plate includes a plurality of first parts and a plurality of second parts alternately disposed in a first direction, and
wherein a slow axis of the first parts and a slow axis of the second parts form an angle of substantially 90 degrees.

3. The optical device of claim 2, wherein the optical modulation device includes a first region corresponding to the first parts and a second region corresponding to the second parts, and
wherein the first region and the second region each respectively include at least one of the unit regions.

4. The optical device of claim 3, wherein the first electrode, the second electrode, and the upper electrode are each configured to receive different voltages from each other when the optical modulation device is turned on, and
wherein a phase inclination direction formed by liquid crystal molecules corresponding to the first region and a phase inclination direction formed by liquid crystal molecules corresponding to the second region are substantially equal to each other.

5. The optical device of claim 4, wherein the display panel includes a polarizer configured to linearly polarize light of the image.

6. The optical device of claim 5, wherein when an electric field is not applied to the liquid crystal layer, a pretilt direction of liquid crystal molecules near the first substrate is opposite to a pretilt direction of liquid crystal molecules near the second substrate.

7. The optical device of claim 3, wherein the first part and the second part are inclined with respect to a second direction perpendicular to the first direction.

8. The optical device of claim 1, wherein when an electric field is not applied to the liquid crystal layer, a pretilt direction of liquid crystal molecules near the first substrate is opposite to a pretilt direction of the liquid crystal molecules near the second substrate.

9. The optical device of claim 8, wherein when the electric field is applied to the liquid crystal layer, an electric field intensity in a region of the liquid crystal layer near the first electrode is higher than an electric field intensity in a region of the liquid crystal layer near the second electrode.

10. The optical device of claim 9, wherein an electric field intensity in a region of the liquid crystal layer near the first substrate is smaller than an electric field intensity in a region of the liquid crystal layer near the second substrate.

11. The optical device of claim 10, wherein a first unit region includes at least one first electrode of the plurality of lower electrodes, and a second unit region includes at least one second electrode of the plurality of lower electrodes.

12. A method for driving an optical device, comprising:
respectively applying voltages of different magnitudes to a first electrode and a second electrode disposed in a first region of an optical modulation device of the optical device including a first substrate to form a first phase inclination that is increased along a first direction; and
respectively applying voltages of different magnitudes to a third electrode and a fourth electrode disposed in a second region of the optical modulation device to form a second phase inclination that is increased along the first direction,
wherein a phase retardation plate of the optical device includes a quarter-wave plate,
wherein the phase retardation plate includes a plurality of first parts and a plurality of second parts alternately disposed in the first direction,
wherein a slow axis of the first part and a slow axis of the second part form an angle of substantially 90 degrees, and
wherein the first region corresponds to the first part, and the second region corresponds to the second part.

13. The method of claim 12, wherein in the first region and the second region, a voltage difference between the voltage applied to the first electrode and a voltage applied to an upper electrode disposed on a second substrate of the optical modulation device is larger than a voltage difference between the voltage applied to the second electrode and the voltage applied to the upper electrode.

14. The method of claim 13, wherein the first substrate includes a first aligner,
wherein the second substrate includes a second aligner, and
wherein an alignment direction of the first aligner and an alignment direction of the second aligner are substantially parallel to each other.

15. The method of claim 14, wherein a display panel of the optical device includes a polarizer linearly polarizing light of an image displayed on the display panel.

16. The method of claim 15, further comprising applying substantially the same voltage to the first electrode, the second electrode, the third electrode, the fourth electrode, and the upper electrode to turn off the optical modulation device, and
wherein when an electric field is not applied to a liquid crystal layer of the optical modulation device, a pretilt direction of liquid crystal molecules near the first substrate is opposite to a pretilt direction of liquid crystal molecules near the second substrate.

17. The method of claim 16, wherein the first region and the second region each include at least one unit region, and
wherein the optical modulation device generates a phase variation from 0 to 2π (radian) in at least one of the unit regions.

18. An optical modulation device, comprising:
a first substrate and a second substrate facing the first substrate, wherein each the first substrate and the second substrate include a first region and a second region; and
a liquid crystal layer disposed between the first substrate and the second substrate, wherein the liquid crystal layer includes a plurality of liquid crystal molecules,
wherein the first substrate includes a first aligner, and a plurality of lower electrodes comprising a first electrode and a second electrode,
wherein the second substrate includes an upper electrode and a second aligner,
wherein an alignment direction of the first aligner and an alignment direction of the second aligner are substantially parallel to each other,
wherein the first electrode, the second electrode, and the upper electrode are each configured to receive different voltages from each other when the optical modulation device is turned on, and
wherein a phase inclination direction formed by liquid crystal molecules corresponding to the first region and a phase inclination direction formed by liquid crystal molecules corresponding to the second region are substantially equal to each other.

19. The optical modulation device of claim 18, wherein when an electric field is not applied to the liquid crystal layer, a pretilt direction of liquid crystal molecules near the first substrate is opposite to a pretilt direction of liquid crystal molecules near the second substrate.

20. The optical device of claim 18, wherein when an electric field is applied to the liquid crystal layer, an electric field intensity in a region of the liquid crystal layer near the first electrode is higher than an electric field intensity in a region of the liquid crystal layer near the second electrode.

21. The optical device of claim 18, wherein an electric field intensity in a region of the liquid crystal layer near the first substrate is smaller than an electric field intensity in a region of the liquid crystal layer near the second substrate.

22. The optical device of claim 18, further comprising a space between the first electrode and the second electrode.
